(19) United States
(12) Patent Application Publication
(10) Pub. No.: US 2019/0142142 A1
(43) Pub. Date: May 16, 2019

(54) Automated Locking Knap Sack

(71) Applicant: Ernest Dushime, Calgory (CA)

(72) Inventor: Ernest Dushime, Calgory (CA)

(21) Appl. No.: 15/814,383

(22) Filed: Nov. 15, 2017

(51) Int. Cl. A45F 3/04; G07C 9/00

(52) U.S. Cl. CPC A45F 3/04; A45F 2003/003; G07C 9/00563

(57) ABSTRACT

A backpack with multiple pockets for convenient storage. Access to the internal pockets, which may be used for carrying expensive electronic products and other important items, will be controlled using a fingerprint scanner.

### BACKGROUND OF THE INVENTION

### 1. Field of the Invention

The present invention relates generally to the field of backpack devices and more specifically relates to a backpack with multiple pockets for convenient storage. Access to the internal pockets, which may be used for carrying expensive electronic products and other important items are structured and arranged to be controlled using a fingerprint scanner.

### 2. Description of the Related Art

A backpack is, in its simplest form, a cloth sack carried on one's back and secured with two straps that go over the shoulders, but there can be variations. Lightweight types of backpacks are sometimes worn on only one shoulder strap. Backpacks are commonly used by hikers and students, and are often preferred to handbags for carrying heavy loads or carrying any sort of equipment, because of the limited capacity to carry heavy weights for long periods of time in the hands.

Today, many people carry the items they may need, including expensive electronics, in backpacks or tote bags, however their items are not very secure. Unfortunately a person can come up behind them or beside them and remove items from their bags without the person even being aware of the actions of these skilled thieves. Therefore, a need exists for a specially designed backpack with controlled access. The access to the internal storage pockets is restricted automatically by a fingerprint scanner.

Various attempts have been made to solve the problems which may be found in the related art but have thus far been unsuccessful. A need exists for an Automated Locking Knap Sack to avoid the above-mentioned problems.

### BRIEF SUMMARY OF THE INVENTION

In view of the foregoing disadvantages inherent in the known art, the present invention provides a novel an Automated Locking Knap Sack. The general purpose of the present invention, which will be described subsequently in greater detail, is to provide a backpack with multiple pockets for convenient storage. Access to the internal pockets, which may be used for carrying expensive electronic products and other important items are structured and arranged to be controlled using a fingerprint scanner. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an Automated Locking Knap Sack, constructed and operative according to the teachings of the present invention.

FIGS. 1-3 show various perspective views illustrating an Automated Locking Knap Sack, according to an embodiment of the present invention.

The various embodiments of the present invention will hereinafter be described in conjunction with the appended drawings.

### DETAILED DESCRIPTION

As discussed above, embodiments of the present invention relate to a backpack device and more particularly to an Automated Locking Knap Sack 1.

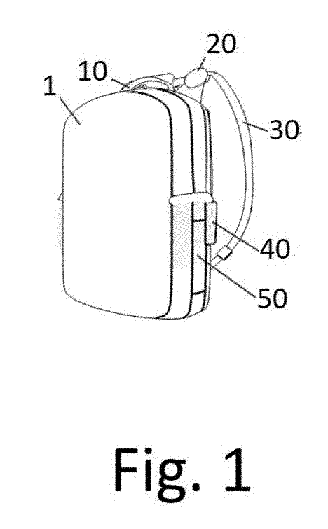

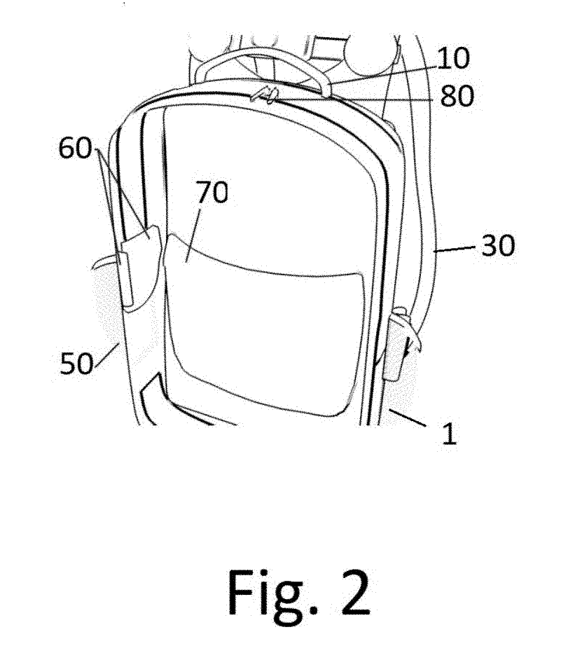

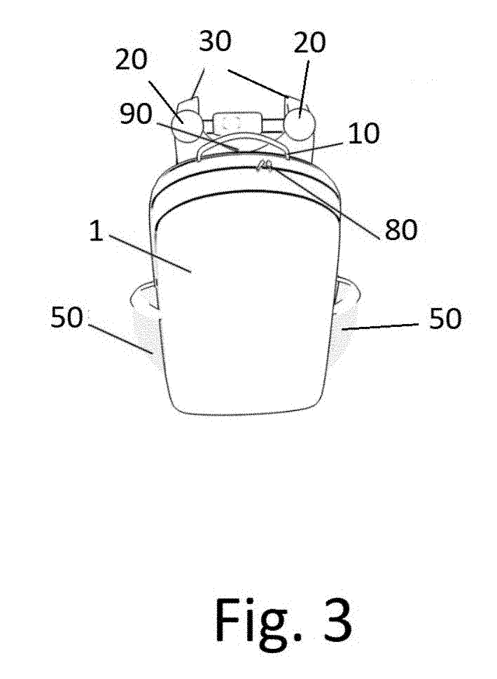

Referring now to the drawings FIGS. 1-3, the Automated Locking Knap Sack 1 is disclosed herein in a preferred embodiment comprising a new backpack is designed to protect one's belongings and expensive electronic devices from being stolen. There are pockets 50 on the outside, not subject to the being unlocked by the fingerprint scanner, for providing convenient access for water bottles, a pen and a stylus. The internal pockets are for storing valuable items, like a laptop or tablet and a wallet. There is a laptop pocket 70 within the knap sack 1. There can also be a pen/wallet pocket 60.

There is a fingerprint scanner 20 attached to the top handle 10, which limits access to the internal pockets. The zippered opening 90 will not be released unless the fingerprints of the person attempting to open it match those programmed onto the scanner 20.

The owner's cell phone fits in a pouch 80 between the straps 30, so they will be able to hear it when there is a call or a message. Backpacks with this technology will be available in various styles, sizes and colors for boys and girls and adults. This same technology can be used for securing suitcases, book bags, handbags, shoulder bags, briefcases, all styles of computer carrying cases, bum bags, and more.

The knap sack 1 can be made of nylon or Kevlar which would make the knap sack 1 waterproof. The Kevlar could also provide additional protection from bullets or other deadly weapons.

In an alternative embodiment, the security scanner can be a facial recognition system.

### Advantages

The unique features of the current invention will provide the following benefits for consumers everywhere:
A way to ensure important belongings carried in one's backpack will be protected from thieves.
Access to the internal pockets will be limited by having to match fingerprints.
Will provide users with greater peace of mind, knowing their electronics, wallets, etc. will be safe when they are being carried in a backpack.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A device comprising;
A knap sack with an opening that is locked with a security scanner.

2. The device according to claim 1 where;
The security scanner is a fingerprint scanner.

3. The device according to claim 1 where;
The security scanner is a facial recognition system.

4. The device according to claim 1 where;
Having a plurality of side pockets.

5. The device according to claim 1 where;
Having a plurality of side pockets.

6. The device according to claim 1 where;
Having a plurality of internal pockets.

7. The device according to claim 1 where;
Being made of Kevlar.

8. The device according to claim 1 where;
Being made of nylon.

9. The device according to claim 1 where;
Having a top side and having a handle at the top of the knap sack.

10. The device according to claim 1 where;
Having a top side and having a handle at the top of the knap sack.

11. The device according to claim 1 where;
Having a plurality of straps.

12. The device according to claim 1 where;
Having a cell phone pocket.
